(19) United States
(12) Patent Application Publication
(10) Pub. No.: US 2013/0340037 A1
(43) Pub. Date: Dec. 19, 2013

(54) DATA STORAGE APPARATUS WITH AUTHENTIFICATION FACILITY AND A METHOD OF AUTHENTIFICATION

(71) Applicant: Ken Lip ONG, Singapore (SG)

(72) Inventor: Ken Lip ONG, Singapore (SG)

(73) Assignee: WRENCH MONKEY DESIGNS PTE LTD, Singapore (SG)

(21) Appl. No.: 13/527,225

(22) Filed: Jun. 19, 2012

(51) Int. Cl. G06F 21/04; G06F 7/04

(52) U.S. Cl. 726/2

(57) ABSTRACT

A data storage apparatus, and specifically a flash drive comprises a first authentication device and a second authentication device apart. The authentication facility is for accessing a storage module of the flash drive. The first authentication device comprises a microphone and is configured to receive a voice signature from the user. If the user requires authentication, the voice signature has to be delivered to the flash drive which will be captured by the microphone and a processing device compares the received voice signature with the stored voice signature. If they match, then authentication is provided. The second authentication device comprises a button or a switch and is used to select a set of colour codes from red and green flashing LEDs. If the colour codes selected is the same as the colour codes stored as compared by the processing device, then authentication is provided.

### TECHNICAL FIELD

This invention relates to a data storage apparatus with authentication facility and a method of authentication. This invention has particular, but not exclusive, application in the field of storage devices.

### BACKGROUND

With every business, commercial and some household processes being associated with computers, the amount of data that is being saved in storage devices have increased in great magnitude. The storage devices can be any kind of devices such as external hard disks, flash drives or thumb drives or similar. With the storage devices going around in great numbers, the risk or losing them or ending up in unwanted or undesirable places are correspondingly greater. Securing access to the storage devices can be a good way of protecting the data stored inside them. In this way, although losing the storage device results in loss of the storage device, the data stored inside the storage device will not be accessible. Additionally, even if the storage device lands in undesirable or unwanted places, the data will again not be accessible by way of securing access to the storage device.

One encryption method currently available for securing access in storage devices is software based encryption. As soon as the storage device is coupled to the host computer, an application is initiated in the host computer that notifies the user to key in the password. Once the correct password is keyed in, access to the storage device is granted. This involves installation of the application in the host computer by the user, which may be time consuming. Secondly, if the password is stolen, then access to the storage device can be easily gained.

Another encryption method involves using the user's fingerprint for authentication. This method which is widely known and understood involves the use of a fingerprint reader and associated processing electronics for comparing the scanned fingerprint with the fingerprint images in the database. This involves bulky fingerprint reading and processing electronics to be embedded in the storage device. With a fingerprint authentication system in every storage device, the market price of the storage device has to include the cost of the fingerprint authentication system which can make it less attractive pricewise, as competition for storage devices is huge.

Additionally, a problem posed by storage devices with encryption methods is that when the encryption hardware or software fails, the process of securing access to the data in the storage device may be virtually impossible or very difficult, time consuming and expensive.

### SUMMARY

According to one aspect of the invention, there is disclosed a data storage apparatus with authentication facility. The data storage apparatus comprises a processing module, a storage module, a first authentication module and a second authentication module. The first authentication module is for receiving biometric information. The processing module is configured to compare the received biometric information with stored biometric information in the data storage apparatus for the purpose of authenticating the received biometric information. The second authentication module is for receiving a set of parameters. The processing module is further configured to compare the selected set of parameters with a stored set of parameters in the data storage apparatus for the purpose of authenticating the selected set of parameters. Further, access to the storage module of the data storage apparatus is enabled by authenticating through one of the first authentication module and the second authentication module.

According to another aspect of the invention, there is disclosed a method of authentication in a data storage apparatus with authentication facility. The method first comprises the step of capturing authentication information. The next step is authenticating the authentication information by comparing the authentication information with stored information in the data storage apparatus to allow access to a storage module of the data storage apparatus. The authentication information is selectable from one of biometric information received by a first authentication module and a set of parameters received by a second authentication module.

### BRIEF DESCRIPTION OF DRAWINGS

FIG. 1 shows a high level architecture of a data storage apparatus with authentication facility

FIG. 2 shows a high level architecture of a processing module in the data storage apparatus

FIG. 3 shows the process steps for capturing and authenticating authentication information for a method of authentication in the data storage apparatus

### DETAILED DESCRIPTION

In the disclosure herein, consideration or use of a particular element number in a given FIG. or corresponding descriptive material can encompass the same, an equivalent, or an analogous element number identified in another FIG. or descriptive material corresponding thereto.

In the present disclosure, the term “set” corresponds to or is defined as a non-empty finite organization of elements that mathematically exhibits a cardinality of at least 1 (i.e., a set as defined herein can correspond to a singlet or single element set, or a multiple element set), in accordance with known mathematical definitions. In general, an element of a set can include or be a system, an apparatus, a device, a structure, an object, a process, a physical parameter, or a value depending upon the type of set under consideration.

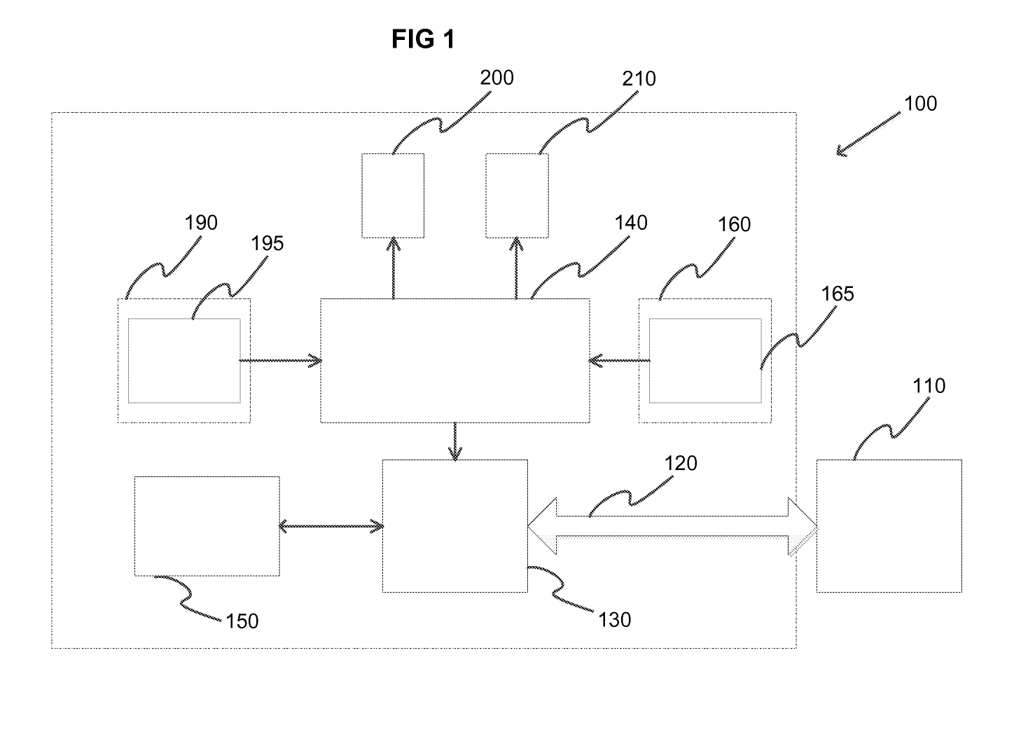

FIG. 1 shows a high level architecture of a data storage apparatus 100 with authentication facility. As illustrated in FIG. 1, the data storage apparatus 100 can be coupled to a computing device 110 through which a user or a person associated with the data storage apparatus 100 can access data inside the data storage apparatus 100 or save or store data in the data storage apparatus 100 after authentication, which will be described below. The computing device 100 can be a notebook, desktop, mainframe, industrial grade computer or any similar device which has capabilities to interact with data storage devices.

The data storage apparatus 100 can couple and interact with the computing device 110 through a communication interface 120. The communication interface 120 can be wired and can be any one of a USB interface, an RS-232 interface, Firewire interface and Ethernet interface. Alternatively, the communication interface 120 can be wireless and can be any one of a wireless USB interface, WiFi interface and Bluetooth interface. The communication interface 120 is not limited to the above and can be any other interface as well. The communication interface 120 is connected to a communication module 130, which will be described below.

Further, the data storage apparatus 100 comprises a processing module 140 and a storage module 150, which will be described subsequently in relation to the authentication facility.

As described earlier, the data storage apparatus 100 has a facility for authenticating the person associated with the data storage apparatus 100 or the user of the data storage apparatus 100. Only after authenticating, the user or the person can access data stored in the data storage apparatus 100 or save or store data in the data storage apparatus 100, which will be described below.

Furthermore, the data storage apparatus 100 comprises a first authentication module 160. The first authentication module 160 comprises a receiving module 165. The first authentication module 160 is connected to the processing module 140 for processing the information received by the first authentication module 160 for the purposes of authentication. The first authentication module 160 uses biometric information from the user of the data storage apparatus 100 or the person associated with the data storage device 100 for the purposes of authentication. Biometric information pertains to physiological information of humans that are unique for every individual. For instance, fingerprints, iris patterns, DNA, voice etc can be used to identify a person using biometric recognition technology. Biometric recognition technology and biometric authentication are known and readily understood by a person skilled in the art. In the example of FIG. 1, the biometric information or characteristic that is used is the speech of a person. Accordingly, the receiving module 165 that is configured to receive biometric information or speech in the example of FIG. 1 is a microphone. The microphone is a conventional microphone that has a small form factor so that it can be built into a housing of the data storage apparatus 100. The speech information or sound is converted into electrical signals by the microphone and transmitted to the processing module 140. The processing module 140 can store biometric information, specifically voice or speech signals which are used to compare with the received biometric information, specifically voice signals. If the biometric information received from the user or the person through the receiving module 165 matches with the stored biometric information in the processing module 140, then the received biometric information is authenticated, in turn authenticating the person or the user associated with the data storage apparatus 100.

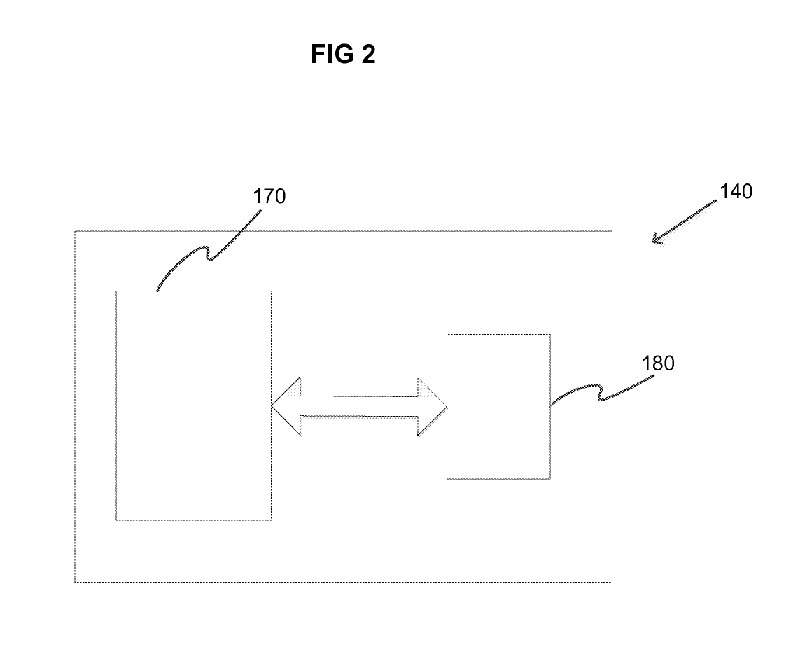

FIG. 2 shows a high level architecture of the processing module 140 in the data storage apparatus 100. The processing module 140 comprises a processing centre 170. The processing centre 170 is an Integrated Chip which has voice/speech processing capabilities. For instance, the RSC 464 can be used which has speech Input/Output capabilities. The above IC is only an example and any other IC having voice or speech I/O capabilities can be used. The processing module 140 also comprises a non-volatile storage centre 180 which stores biometric information, specifically the speech signal. The speech signal stored in the non-volatile storage centre 180 serves as a template for authentication by the first authentication module 160.

When the first authentication module 160 is activated, the data storage apparatus 100 goes into a first authentication mode and the speech signal received by the microphone 165 is transmitted to the processing module 140 and specifically to the processing centre 170. The processing centre 170 compares the received speech signal with a speech template that is stored in the non-volatile storage centre 180. If the received speech signal is similar to or exactly the same as the stored speech template, then the process of authentication is initiated by the processing module 140. The processing module 140 sends instructions to the communication module 130 to allow the computing device 110 to access the storage module 150 of the data storage apparatus 100. This will enable data to be transmitted from the computing device 110 and saved in the storage module 150 through the communication interface 120. The authentication will also enable data to be transmitted from the storage module 150 to the computing device 110 through the communication interface 120. An example of the speech template and the speech signal received by the first authentication module 160 can be the word “ACCESS”. However, this is just an example and any word can be sued as the speech signal. The process of comparison of the speech signal to the stored speech template by the IC described above or any other speech voice/processing unit is understood by the person skilled in the art.

Moreover, the data storage apparatus 100 comprises a second authentication module 190. The second authentication module 190 comprises a selector or tool 195. The selector 195 can be one of a button and a switch that is built into the housing of the data storage apparatus 100. The selector 195 is connected to the processing module 140 and is configured to receive a set of parameters. The set of parameters are received from the user or the person associated with the data storage apparatus 100. To elaborate, the set of parameters are selected by actuating or tapping or switching the selector 195. Further, the electrical signals from the tapping or switching of the tool 195 are transmitted to the processing centre 170. The processing module 140 and specifically the processing centre 170 is connected to a green light emitting device 200 and a red light emitting device 210. The green light emitting device 200 and the red light emitting device 210 can be controlled by the processing module 140, and specifically by the processing centre 170. In other words, the green light emitting device 200 and the red light emitting device 210 can be turned on individually or together by the processing centre 170, by techniques which are readily known and understood by the person skilled in the art. The set of parameters described above refer to a set of colour codes. In the example of FIG. 1, the set of colour codes comprises six colour codes. Six is just an example, but the data storage apparatus 100 can be configured to include more than six colour codes in the set of colour codes. Moreover, the set of colour codes include colours red and green in the example of FIG. 1. However, the colours are not limited to red and green and can include other colours as well. To elaborate, the set of six colour codes comprise colours from green and red, associated with the green light emitting device 200 and the red light emitting device 210. For instance, the six colours can be RED GREEN RED GREEN RED GREEN or RED RED RED GREEN GREEN GREEN or RED RED GREEN RED GREEN GREEN or RED GREEN RED+GREEN GREEN RED GREEN or any other possible combination.

When the second authentication module 190 is activated, the set of parameters selected by the selector 195 is compared with a set of parameters that is stored in the processing module 140, and specifically in the non-volatile storage centre 180. The stored set of parameters, for instance, can also be RED GREEN RED GREEN RED GREEN or RED RED RED GREEN GREEN GREEN or RED RED GREEN RED GREEN GREEN or RED GREEN RED+GREEN GREEN RED GREEN or any other possible combination.

When the second authentication module 190 is activated, the data storage apparatus 100 goes into a second authentication mode wherein the second authentication module 190 receives the set of parameters, which is described below. In the second authentication mode, the processing centre 170 turns on the green light emitting device 200 or the red light emitting device 210 or both the green light emitting device 200 and the red light emitting device 210 simultaneously. To elaborate, the green light emitting device 200 is first turned on followed by the red light emitting device 210 and then subsequently both the green light emitting device 200 and the red light emitting device 210. The above sequence of turning on is just an example and can be in any other order as well. The sequence of turning on the light emitting devices continues until all the six colours in the set of colour codes are selected. When the selector 195 is actuated when the green light emitting device 200 is turned on, then GREEN is selected as an element of the set of parameters or set of colour codes. When the selector 195 is actuated when the red light emitting device 210 is turned on, then RED is selected as an element of the set of parameters or set of colour codes. When the tool 195 is actuated when the green light emitting device 200 and the red light emitting device 210 are turned on, then GREEN and RED are selected as an element of the set of parameters or set of colour codes. So, for instance, the stored set of parameters is RED GREEN RED GREEN RED RED+GREEN. In the second authentication mode, the user or the person associated with the data storage apparatus 100 has to select RED GREEN RED GREEN RED RED+GREEN to be authenticated and gain access to the storage module 150 of the data storage apparatus 100. If the following series of colours forming the set of colour codes is selected by the technique as described above when the light emitting devices are alternately and simultaneously turned on by the processing centre 170, then authentication is provided. Even if one element of the set of colour codes above is different, then authentication will not be provided. If authentication is not provided, then the light emitting devices are turned on both individually and together as above for the second round of selection of the set of colour codes.

If authentication is successful, then the processing module 140 sends instructions to the communication module 130 to allow the computing device 110 to access the storage module 150 of the data storage apparatus 100. This will enable data to be transmitted from the computing device 110 and saved in the storage module 150 through the communication interface 120. The authentication will also enable data to be transmitted from the storage module 150 to the computing device 110 through the communication interface 120.

The data storage apparatus 100 can be configured in such a way that when the data storage apparatus 100 is coupled to the computing device 110, the data storage apparatus 100 automatically goes into the first authentication mode. The user or the person associated with the data storage apparatus 100 can proceed to be authenticated in the first authentication mode or select the second authentication mode by actuating the selector 195 more than once, and specifically twice. Once the selector 195 is actuated, the data storage apparatus 100 goes into the second authentication mode. Alternately, the data storage apparatus 100 can be configured in such a way that when the data storage apparatus 100 is coupled to the computing device 110, the data storage apparatus 100 automatically goes into the second authentication mode. The user or the person associated with the data storage apparatus 100 can proceed to be authenticated in the second authentication mode or select the first authentication mode by actuating the tool 195 more than once, and specifically twice. Once the tool 195 is actuated, the data storage apparatus 100 goes into the first authentication mode. Actuating the selector 195 twice is just an example. However, the data storage apparatus 100 can be configured such that the selector 195 be actuated more than twice as well.

The advantage of having two selectable authentication modules is that, if one authentication module fails, the other authentication module can be used for authentication. The other advantage is that the user or the person associated with the data storage apparatus 100 can choose and select the authentication modules that he or she wants to be authenticated with.

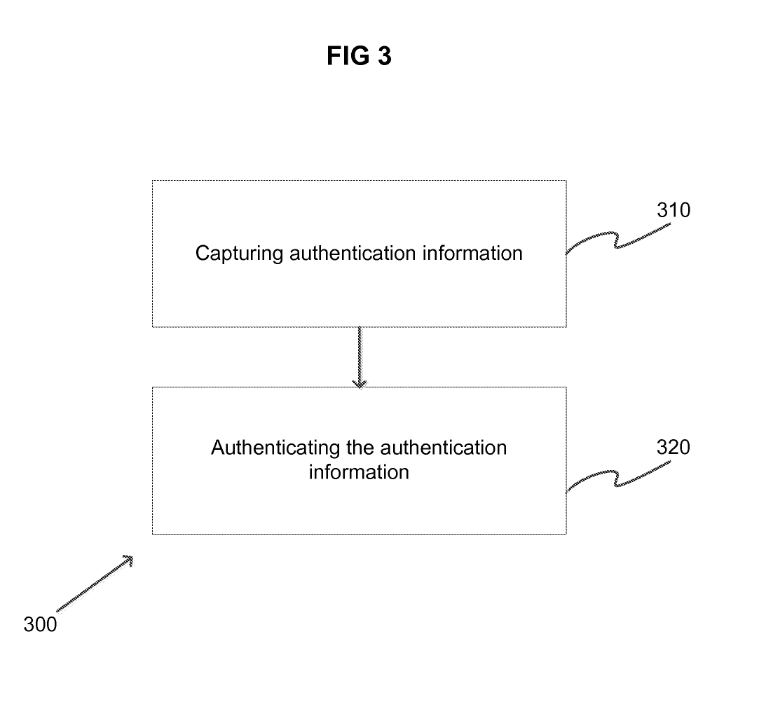

FIG. 3 shows the process steps for capturing and authenticating authentication information for a method 300 of authentication in the data storage apparatus 100. As illustrated in FIG. 3, a method 300 of authentication in the data storage apparatus 100 with authentication facility is described below. The method 300 comprises a step 310 which comprises capturing authentication information. The authentication information can be selectable from one of the biometric information and the set of parameters which has been described earlier. The capturing of the authentication information is through one of the first authentication module and the second authentication module which has also been described earlier. After the step 310, the method 300 proceeds to a step 320 which comprises authenticating the authentication information received in the step 310. The authentication is performed by comparing the received authentication information with the stored information in the data storage apparatus. The stored information can be one of stored biometric information and the stored set of parameters. The process of comparing for both the biometric information and set of parameters has been described earlier.

The method 300 further comprises activating one of the first authentication module 160 and the second authentication module 190 by a processing module 140 of the data storage apparatus 100 subsequent to the data storage apparatus 100 being coupled to the computing device 110. Moreover, this step is configured to occur before the step 310 described earlier. By activating the first authentication module 160, the data storage apparatus 100 goes into the first authentication mode and by activating the second authentication module 190, the data storage apparatus 100 goes into the second authentication mode, which has been described earlier.

If the user or the person associated with the data storage apparatus 100 wishes to authenticate through the second authentication module 190 when the first authentication module has been activated upon connecting to the computing device 110 or wishes to authenticate through the first authentication module 160 when the second authentication module has been activated upon connecting to the computing device 110, then an authentication selection input is used to select the authentication module alternate to the authentication module that has been activated upon connecting the data storage apparatus 100 to the computing device 110. To elaborate, the method 300 further comprises receiving the authentication selection input to activate the other of the first authentication module 160 and the second authentication module 190 immediately subsequent to activating one of the first authentication module 160 and the second authentication module 190.

It is to be understood that the foregoing description is intended to be purely illustrative of the principles of the disclosed techniques, rather than exhaustive thereof, and that changes and variations will be apparent to those skilled in the art, and that the present invention is not intended to be limited other than as expressly set forth in the following claims.

1. A data storage apparatus with authentication facility, comprising:
a processing module;
a storage module;
a first authentication module for receiving biometric information; the processing module configured to compare the received biometric information with stored biometric information contained in the data storage apparatus to authenticate the received biometric information,
a second authentication module for receiving a set of parameters; the processing module configured to compare the set of parameters with a stored set of parameters contained in the data storage apparatus to authenticate the selected set of parameters,
wherein access to the storage module of the data storage apparatus is enabled by authenticating through one of the first authentication module and the second authentication module.

2. The data storage apparatus as claimed in claim 1, wherein the processing module is configured to activate one of the first authentication module and the second authentication module subsequent to the data storage apparatus being coupled to a computing device.

3. The data storage apparatus as claimed in claim 2, wherein upon activation of one of the first authentication module and the second authentication module, the processing module is further configured to receive an authentication selection input from the person associated with the data storage apparatus to activate the other of the first authentication module and the second authentication module.

4. The data storage apparatus as claimed in claim 1, wherein the first authentication module comprises a receiving module, the receiving module being a microphone.

5. The data storage apparatus as claimed in claim 4, wherein the biometric information received by the receiving module is sound from the person.

6. The data storage apparatus as claimed in claim 5, wherein the sound from the person is the speech of the person.

7. The data storage apparatus as claimed in claim 1, wherein the second authentication module comprises a selector, the selector being one of a button and a switch.

8. The data storage apparatus as claimed in claim 7, wherein the set of parameters is a set of colour codes.

9. The data storage apparatus as claimed in claim 8, wherein the set of colour codes comprise six colour codes, the colours in the set of colour codes selectable from a red light emitting device and a green light emitting device.

10. The data storage apparatus as claimed in claim 9, wherein the tool is configured to select red by pressing the tool when the red light emitting device is emitting red light and select green by pressing the tool when the green light emitting device is emitting green light.

11. A method of authentication in a data storage apparatus with authentication facility, comprising:
capturing authentication information; and
authenticating the authentication information by comparing the authentication information with stored information in the data storage apparatus to allow access to a storage module of the data storage apparatus, wherein the authentication information is selectable from one of biometric information received by a first authentication module and a set of parameters received by a second authentication module.

12. The method as claimed in claim 11, wherein authenticating the authentication information by comparing the authentication information with stored information in the data storage apparatus comprises:
authenticating one of the biometric information by comparing the biometric information with stored biometric information contained in the data storage apparatus and the set of parameters by comparing with a stored set of parameters contained in the data storage apparatus.

13. The method as claimed in claim 11, further comprising:
activating one of the first authentication module and the second authentication module by a processing module of the data storage apparatus subsequent to the data storage apparatus being coupled to a computing device and prior to capturing authentication information.

15. The method as claimed in claim 14, further comprising:
receiving an authentication selection input to activate the other of the first authentication module and the second authentication module immediately subsequent to activating one of the first authentication module and the second authentication module by a processing module of the data storage apparatus.
